(19) United States
(12) Patent Application Publication
(10) Pub. No.: US 2021/0406341 A1
(43) Pub. Date: Dec. 30, 2021

(54) UNSUPERVISED DISAGGREGATION APPARATUS, METHOD AND COMPUTER-READABLE MEDIUM

(71) Applicant: NEC Corporation, Minato-ku, Tokyo (JP)

(72) Inventors: Murtuza PETLADWALA, Tokyo (JP); Ryota SUZUKI, Tokyo (JP)

(73) Assignee: NEC Corporation, Minato-ku, Tokyo (JP)

(21) Appl. No.: 17/295,520

(22) PCT Filed: Nov. 26, 2018
(86) PCT No.: PCT/JP2018/043404

§ 371 Date: May 20, 2021

(51) Int. Cl. G06F 17/16

(52) U.S. Cl. CPC G06F 17/16

(57) ABSTRACT

An unsupervised disaggregation method includes estimating, from an observation matrix X, by using a latent feature model approach, a binary matrix Z and a latent feature matrix W; calculating a dot product of the matrix W and a D dimensional vector x; repeating, for each row of the matrix W, checking that the dot product value for the row of the matrix W with the vector x is negative to discard the row from the matrix W and a corresponding column from the binary matrix Z; if any discarded row present in the matrix W, updating the matrices W and Z using new matrix W_{new} and Z_{new} including respectively un-discarded rows of the matrix W, and un-discarded columns of the matrix Z to iterate from the estimation of the matrices W and Z from the matrix X, until no row discarded in the matrix W.

This application is a National Stage Entry of PCT/JP2018/043404 filed on Nov. 26, 2018, the contents of all of which are incorporated herein by reference, in their entirety.

### FIELD

The present invention relates to unsupervised disaggregation apparatus, method and computer-readable medium.

### BACKGROUND

Disaggregation technology is used to estimate a state(s), e.g., operation state(s) of an individual electric appliance from an aggregate (synthetic) signal such as power consumption, of a plurality of electric appliances (hereinafter termed as “appliances”) that is acquired by non-intrusive load monitoring (NILM).

In NILM (Non-Intrusive Load Monitoring), the current waveform measured for example, in a household or factory, from a power distribution board, the power consumption or the like of each household or factory appliance is estimated. For example, using current measured in a location, power consumption of each household electrical appliance connected ahead therefrom can be obtained without measurement of individual appliances.

A disaggregation system performs disaggregation of the aggregate signal into an individual signal of each appliance, for example, in case of supervised disaggregation, pattern matching is performed with respective learned models of waveform data of each appliance.

The unsupervised disaggregation of electric current waveform of a single appliance disaggregates into individual units of appliance. The units of appliance may refer to internal parts of the appliance that mainly consist of resistors, inductors, capacitors and thyristors and alike components. In a working electric appliance, there are combinations of all these internal parts. Disaggregation of these combinational units of electric appliance from a source current waveform consumption with an unsupervised approach is disclosed in this application. The disaggregation can be applied to any electric facility like home, building, factory and so on; though not limited thereto.

As an algorithm for disaggregation, Factorial Hidden Markov Model (FHMM), Combinatorial Optimization, Blind Source Separation and so forth may be utilized.

For example, NPTL 1 discloses an NILM technique using Factorial Hidden Markov Model (FHMM). In a FHMM based disaggregation (supervised), a state model structure with a fixed number of nodes (states) and fixed number of edges is usually adopted. As a simple case of FHMM, one appliance corresponds to one factor, wherein each factor represents a state model structure.

Latent Feature Model (LFM) is a direct generalization of mixture model where each observation is an additive combination of several latent features. In the latent feature model (LFM), each instance is generated not from a single latent class but from a combination of latent features and each instance has an associated latent binary feature incidence vector (binary vector) indicating presence or absence of a feature. Models used in unsupervised learning show relative singular representations of the data.

The simplest representation, used in mixture models, associates each object with a single latent class. This approach is suitable when objects can be partitioned into relatively similar subsets like clustering methods. However, the properties of many objects are better captured by representing each object using multiple latent features. For example, select each latent feature as a binary vector, with entries indicating the presence or absence of each internal unit waveform, representing data in a latent space.

Unsupervised learning recovers a latent structure responsible for generating observed properties or attributes of a set of objects. In latent feature modeling, one or more attributes of each object can be represented by an unobserved vector of latent features.

Disaggregation of an aggregate waveform signal into individual waveform signals of individual internal units is a combinatorial problem or combinatorial optimization problem. Therefore, recovering latent features from the aggregate waveform signal is a computationally complex problem. The latent features estimated are converted back to recover an individual waveform signal of an individual internal unit.
NPTL 1: Zoubin Ghahramani, and Michael I. Jordan, Factorial Hidden Markov Models', Machine Learning Volume 29, Issue 2-3, November/December 1997
NPTL 2: Ian En-Hsu Yen, Wei-Cheng Lee, Sung-En Chang, Arun Sai Suggala, Shou-De Lin, Pradeep Ravikumar, “Latent Feature Lasso”, Proceedings of the 34th International Conference on Machine Learning, PMLR 70:3949-3957, 2017
NPTL 3: Ryota Suzuki, Shingo Takahashi, Murtuza Petladwala, Shigeru Kohmoto, “Solving Non-identifiable Latent Feature Models”, Preprint retrieved from the Internet <URL:https://arxiv.org/pdf/1809.03776.pdf>

### SUMMARY

As described above, unsupervised disaggregation of an aggregate waveform signal into individual waveform signal of individual internal unit is a combinatorial problem or combinatorial optimization problem. Recovering latent features from the aggregate waveform signal is a computationally complex problem. The latent features estimated are converted back to recover an individual waveform signal of its corresponding individual internal unit.

When performing disaggregation of the aggregate waveform into individual waveform signals of individual internal units based on LFM, there are such cases, where the recovered waveform signal of an individual internal unit is inappropriate due to incorrect estimation of the latent features.

One of the reasons for causing the incorrect estimation is the model optimization solution falls in incorrect local minima where the recovered electric current signal from latent features is out of phase with the phase of measured signal.

Accordingly, it is an object of the present invention to provide an apparatus, a method, and a program recording medium, each making it possible to perform automatic unsupervised disaggregation of an aggregate waveform into appropriate individual waveform signal of internal units using LFM.

According to an aspect of the present invention, there is provided an unsupervised disaggregation apparatus comprising a processor and a memory coupled to the processor and program instructions to be executed by the processor. The processor executes the process comprising:

creating an observation matrix X including N number of D-dimensional observation vectors, each composed of a measured aggregate waveform that is a sum of a plurality of individual waveform signals of a plurality of internal units;

estimating, by using a latent feature model approach, a binary matrix Z with N rows and K columns and a latent feature matrix W with K rows and D columns, from the observation matrix X with N rows and D columns, where N, D, and K are predetermined positive integers; calculating a dot product of the latent feature matrix W and a D dimensional vector x, a dot product of which with each row of the latent feature matrix W is assumed to give a positive value;

repeating, for i=1 to K, checking whether or not a result of the dot product for the i-th row of the latent feature matrix W with the D dimensional vector x is negative, and if the result of the dot product is negative, discarding the i-th row from the latent feature matrix W and discarding i-th column from the binary matrix Z;

checking whether or not there exists at least one discarded row in the latent feature matrix W, and as a result of the checking,

if there exists at least one discarded row in the latent feature matrix W,

using a new latent feature matrix W_{new}, each row thereof being a row of the latent feature matrix W, the dot product of the row thereof with the D dimensional vector x being non-negative and not discarded, updating the latent feature matrix W, and using a new binary matrix Z_{new}, each column thereof being a column of the binary matrix Z not discarded, updating the binary matrix Z; and

performing iteration from the estimation of the matrices Z and W from the observation matrix X using the updated matrices Z and W, until there is no discarded row in the latent feature matrix.

According to an aspect of the present invention, there is provided a computer-based disaggregation method comprising:

creating an observation matrix X including N number of D-dimensional observation vectors, each composed of a measured aggregate waveform that is a sum of a plurality of individual waveform signals of a plurality of internal units;

estimating, by using a latent feature model approach, a binary matrix Z with N rows and K columns and a latent feature matrix W with K rows and D columns, from the observation matrix X with N rows and D columns, where N, D, and K are predetermined positive integers;

calculating a dot product of the latent feature matrix W and a D dimensional vector x, a dot product of which with each row of the latent feature matrix W is assumed to give a positive value;

repeating, for i=1 to K, checking whether or not a result of the dot product for the i-th row of the latent feature matrix W with the D dimensional vector x is negative, and if the result of the dot product is negative, discarding the i-th row from the latent feature matrix W and discarding i-th column from the binary matrix Z;

checking whether or not there exists at least one discarded row in the latent feature matrix W, and as a result of the checking,

if there exists at least one discarded row in the latent feature matrix W,

using a new latent feature matrix W_{new}, each row thereof being a row of the latent feature matrix W, the dot product of the row thereof with the D dimensional vector x being non-negative and not discarded, updating the latent feature matrix W, and using a new binary matrix Z_{new}, each column thereof being a column of the binary matrix Z not discarded, updating the binary matrix Z; and

performing iteration from the estimation of the matrices Z and W from the observation matrix X using the updated matrices Z and W, until there is no discarded row in the latent feature matrix.

According to an aspect of the present invention, there is provided a (non-transitory) computer-readable recording medium storing therein a program causing a computer to execute processing comprising:

creating an observation matrix X including N number of D-dimensional observation vectors, each composed of a measured aggregate waveform that is a sum of a plurality of individual waveform signals of a plurality of internal units;

estimating, by using a latent feature model approach, a binary matrix Z with N rows and K columns and a latent feature matrix W with K rows and D columns, from the observation matrix X with N rows and D columns, where N, D, and K are predetermined positive integers;

calculating a dot product of the latent feature matrix W and a D dimensional vector x, a dot product of which with each row of the latent feature matrix W is assumed to give a positive value;

repeating, for i=1 to K, checking whether or not a result of the dot product for the i-th row of the latent feature matrix W with the D dimensional vector x is negative, and if the result of the dot product is negative, discarding the i-th row from the latent feature matrix W and discarding i-th column from the binary matrix Z;

checking whether or not there exists at least one discarded row in the latent feature matrix W, and as a result of the checking,

if there exists at least one discarded row in the latent feature matrix W,

using a new latent feature matrix W_{new}, each row thereof being a row of the latent feature matrix W, the dot product of the row thereof with the D dimensional vector x being non-negative and not discarded, updating the latent feature matrix W, and using a new binary matrix Z_{new}, each column thereof being a column of the binary matrix Z not discarded, updating the binary matrix Z; and

performing iteration from the estimation of the matrices Z and W from the observation matrix X using the updated matrices Z and W, until there is no discarded row in the latent feature matrix.

The recording medium may be a non-transitory computer-readable recording medium such as a semiconductor memory (Random Access Memory (RAM), Read Only Memory (ROM), Electrically Erasable and Programmable Read Only Memory (EEPROM), flash memory, or the like), Hard Disk Drive (HDD), Solid State Drive (SSD), Compact Disc, Digital Versatile Disc, and so forth).

According to the present invention, it is made possible to perform disaggregation of an aggregate waveform into appropriate individual waveform signals of internal units of an electric appliance or any electric facilities using LFM.

### BRIEF DESCRIPTION OF DRAWINGS

FIGS. 1A, 1B and 1C are schematic diagrams for explaining an operation of a first example embodiment.

FIG. 2 is a diagram illustrating an arrangement of a first example embodiment.

FIG. 3 is a diagram illustrating an arrangement of a second example embodiment.

FIG. 4 is a flow chart illustrating an operation of the first example embodiment.

FIG. 5 is a flow chart illustrating an operation of the second example embodiment.

FIG. 6 is a diagram illustrating an operation of the step S412 of FIG. 5.

FIG. 7 shows the simulation results.

FIG. 8 is a diagram of an example embodiment.

FIG. 9 is a diagram of an example embodiment.

### DETAILED DESCRIPTION

The following describes example embodiments of the present invention.

The present invention provides an apparatus comprising an automatic optimization function for convergence of a latent feature model. That is, a latent feature model is employed to separate an observation matrix X (each row vector of which including an observed waveform) into a latent feature matrix W (each row vector of which includes, as a latent feature, an estimated individual waveform of each internal unit) and a binary matrix Z (each row vector of which includes elements indicating presence/absence of a corresponding latent feature).

Each phase of the estimated waveform (row vector of the latent feature matrix W) is matched with a phase of an observed waveform (row vector of the observation matrix X). The matching of phase is important because the observed waveform phase is aligned with the phase of a voltage waveform, which generates a positive power value, while the out of phase estimated waveforms generate a negative power value, which is an incorrect solution. This matching process contributes to convergence to a minimum disaggregation error. Simulation results (described later) show that the disclosed invention reduces separation error (disaggregation error) and it is made possible to estimate the latent feature matrix W (e.g., individual waveforms of internal units) correctly with accurate matching of phases.

Unsupervised learning recovers a latent structure responsible for generating observed properties or attributes of a set of objects. In latent feature modeling, one or more attributes of each object can be represented by an unobserved vector of latent features.

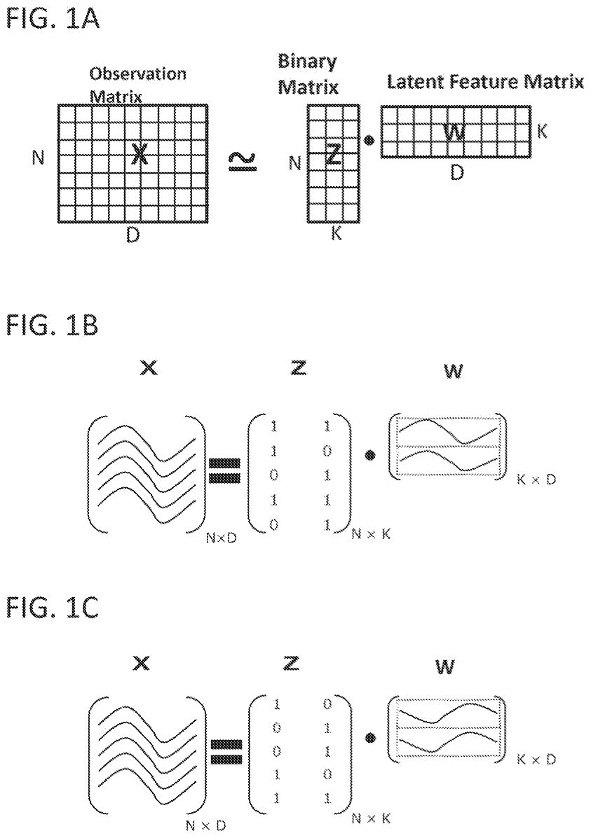

FIG. 1A schematically illustrates the latent feature model (LFM), wherein observation vector x, (i=1, . . . , N) is approximated by sum of combinations of K row vectors of W (reference may be made to NPTL 2).

xᵢ=Zᵢ·W+εᵢ (1)

where
xᵢ∈R^{D}: observation vector (D-dimensional i-th row vector of real number),
W∈R^{K×D}: latent feature matrix which is composed of K latent-feature row vectors of D-dimension),
zᵢ∈{0,1}^{K}: binary vector (K-dimensional i-th row vector, also termed as latent indicator),
εᵢ∈R^{D}: noise (D-dimensional i-th row vector).

In the latent feature modeling, there are known approaches such as IBP (Indian Buffet Process) and matrix-factorization to compute latent feature matrix W that best approximates the observation X_{N×D}.

It is assumed that the observations are generated from a distribution determined by latent feature values.

In FIG. 1B, each observation row vector xᵢ (i=1 to N=5) of the observation matrix X is illustrated as a waveform data of length D, where N number of the observation row vectors compose a N×D the observation matrix X. Each latent feature row vector of the latent feature matrix W is illustrated as a waveform data (estimated waveform data) of length D, where K number of the latent feature row vectors compose a K×D latent feature matrix W. Each binary row vector of the binary matrix Z includes K elements, each of which indicates presence/absence of a corresponding row vector of the latent feature matrix W. N number of the binary row vectors compose a N×K binary matrix Z.

FIG. 1B illustrates correct estimation of the matrix W, while FIG. 1C illustrates incorrect estimation of the matrix W. The estimated waveform has a phase different from a measured (observed) phase of the waveform (measured waveform) as depicted in the FIG. 1C. More specifically, in FIG. 1C, the phase of the estimated waveform (latent feature row vector of the latent feature matrix W) is out of phase by 180 degrees from the measured waveform (observation row vector of the matrix X).

Whether the latent feature matrix W is estimated correctly or not can be judged by comparing phases of the observed waveform and the estimated waveform.

A mismatch in phases of current waveforms may result in a negative value of a power (effective power). The power (effective power) is calculated by sum (integral) of an instantaneous power over one AC power supply cycle, for example, where the instantaneous power is given by multiplication of an instantaneous current value (an element of a current waveform) and a corresponding instantaneous voltage value (corresponding element of a voltage waveform).

It is noted that an instantaneous power assumes a negative value which corresponds to such an operation in which energy accumulated in a capacitor (condenser) in a load is returned to a power supply or energy is generated by a regenerative operation of the load such as a motor or the like, while a positive value of an instantaneous power corresponds to an operation in which an energy is consumed in a load or accumulated in a capacitor, inductor (coil) or the like in the load, but the effective power should assume a non-negative value.

The incorrect estimation of the matrix W can be found if a phase of a waveform estimated is different from a phase of the observed (measured) waveform. The incorrect estimation of the matrix W may include an inverted waveform, which is out-of-phase from the measured waveform.

The inverted waveform is incorrect because the estimated waveforms (row vectors of the latent feature matrix W) should have the same phase as that of the measured waveform (observation row vector of the observation matrix X).

Since the inverted waveform may generate a negative value of a power, the inverted waveform is not a suitable latent feature.

Some of the latent features may be inverted waveforms, or all the latent features may be inverted waveforms, or none of the latent feature may be inverted waveforms.

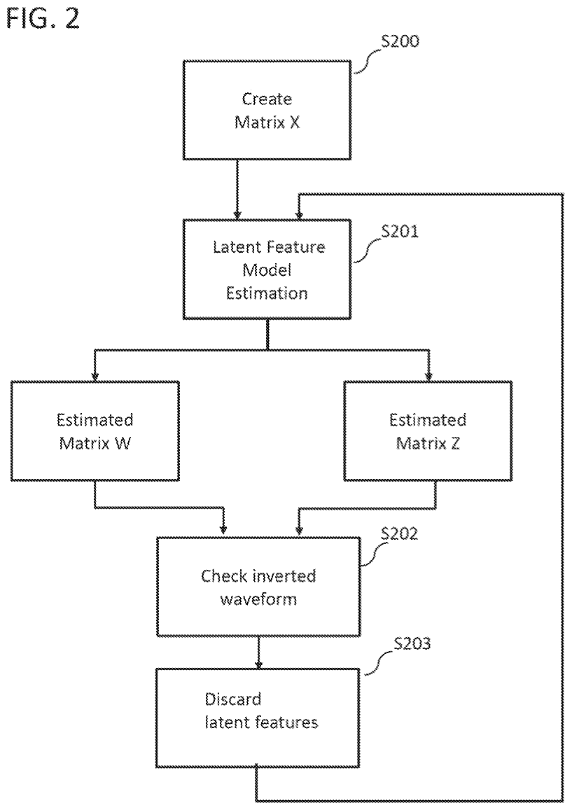

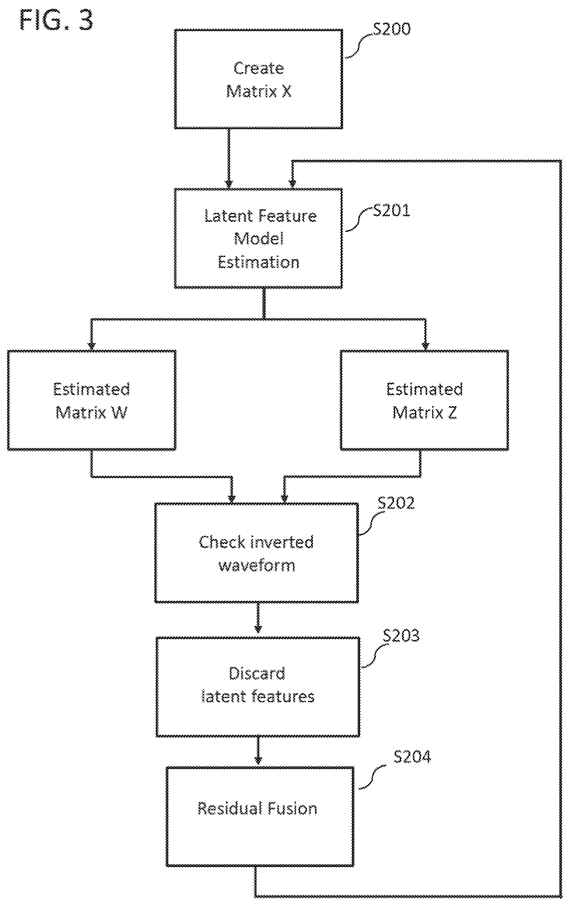

Depending on initial parameters, the solution might change due to multiple local minima problem. The solution for above described problem is to introduce a post-process step, after a model estimation step (S201 in FIGS. 2 and 3) which estimates a latent feature matrix W and a binary matrix Z from the observation matrix X.

The post-process step includes:

an optimization loop to optimize a non-inverted waveform(s) with minimized error solution.

The post-process step may include the following 2 steps, as illustrated in FIG. 2 (first example embodiment).

Step 1. Check inverted waveform (S202); and
Step 2. Discard latent feature (S203).

Alternatively, the post-process step may include the following three steps as illustrated in FIG. 3 (second example embodiment).

Step 1. Check inverted waveform (S202);
Step 2. Discard latent feature (S203); and
Step 3. Residual fusion (S204).

In FIGS. 2 and 3, a create matrix X step (S200) creates N×D observation matrix by acquiring N cycles of waveforms of length D from a measurement device such as a current sensor (CT (Current Transformer)) that is disposed in a distribution board and measures an aggregate alternate current signal which is a sum of current of a plurality of electric appliances (internal units). N cycles of waveform data are stored in N row vectors to create N×D observation matrix X.

A latent feature model estimation step (S201) estimates a latent feature matrix W and a binary matrix Z from the observation matrix X.

The check inverted waveform step (S202) checks if there exists any inverted waveform in the estimated matrix W. This step (S202) is located after the latent feature model estimation step (S201).

The check inverted waveform step (S202) is supplied with the estimated matrix W, Z and a vector x. The vector x is of length D, which may be a mean row vector of N observation row vectors xᵢ (i=1, . . . , N) of the observation matrix X, voltage signal, phase vector, or, any vector such that a linear dot product of the matrix W and the vector x produces a positive value.

When the check inverted waveform step (S202) finds an inverted waveform in the estimated matrix W, the discard latent feature step (S203) discards the inverted waveform (row vector) from the latent feature matrix W, and updates the binary matrix Z.

In FIG. 2, the binary matrix Z and latent feature matrix W are updated by those obtained by the discard latent feature step (S203) and the latent feature model estimation step (S201) is re-executed if the updated latent feature matrix W_{new} is not equal to the estimated latent feature matrix W.

In FIG. 3, the residual fusion step (S204) obtains a residue obtained by subtracting a product of the matrix Z and the matrix W from the observation matrix X to obtain residual from the estimation. In this step, residual latent features are concatenated to the latent features and the latent feature model estimation step (S201) is re-executed.

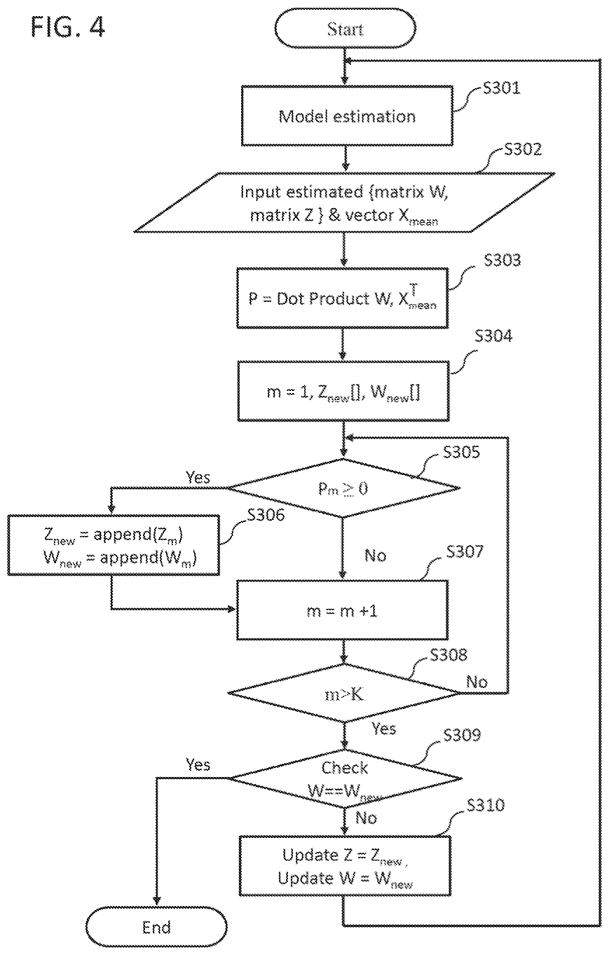

FIG. 4 is a flow chart illustrating the examples of the steps S202 and S203in FIG. 2 in more detail.

In FIG. 4, step S301 corresponds to the step S201 of FIG. 2, step S305 corresponds to the check inverted waveform step S202 of FIG. 2, and steps 306 and S307 correspond to the discard latent feature step S203 of FIG. 2.

In step S301, using latent feature model, the latent feature matrix W, and the binary matrix Z are estimated.

In step S302 the estimated matrices W, and Z, and the vector x denoted as Xₘₑₐₙ which is obtained as a mean vector of N observation row vectors of the observation matrix X are inputted.

$${X}_{m e a n} = \frac{1}{N} {\sum }_{i = 1}^{N} {x}_{i} \qquad ( 2 )$$

where xᵢ is i-th row vector of the matrix X.

The matrix W is of size K×D (K rows and D columns), the matrix Z is of size N×K (N rows and K columns) and the vector Xₘₑₐₙ is of length D (D-dimensional row vector).

In step S303, a K-dimensional column vector P is obtained by the dot product of the matrix W and the vector Xₘₑₐₙ,

P_{(K×1)}×W_{(K×D)}·Xₘₑₐₙ^{T} (3)

where T is a transpose operator.

That is, i-th element Pᵢ of the column vector P is given as:

$${P}_{i} = {\sum }_{j = 1}^{D} {W}_{i , j} \cdot {x}_{j} \\ i = 1 , … , K \qquad ( 4 )$$

where W_{i,j} (1=<i=<K, 1=<j=<D) is a (i, j) element of the K×D latent feature matrix W and xj is j-th element of the D-dimensional row vector Xₘₑₐₙ.

In step S304, a loop variable m is initialized and a matrices W_{new} (new latent feature matrix) and Z_{new} (new binary matrix) are initialized to null.

In step S305, it is checked whether Pₘ (given by the equation (4) with an index i set to m, i.e., a value of the loop variable) is not less than zero (i.e., greater than or equal to zero).

If Pₘ is greater than or equal to zero (branch “Yes” of S305), m-th column vector Zₘ of the binary matrix Z and m-th row vector Wₘ of the latent feature matrix W are appended respectively to the matrices Z_{new} and W_{new}, respectively (step S306). More specifically, the m-th column vector Zₘ is appended as a column next to the last column of the new binary matrix Z_{new}. When the new binary matrix Z_{new} is in the initialized state, i.e., null, the m-th column vector Zₘ is placed in the first column of the new binary matrix Z_{new}. In the same way, the m-th row vector Wₘ is appended as a row next to the last row of the new latent feature matrix W_{new}. When the new latent feature matrix W_{new} is in the initialized state, i.e., null, the m-th row vector Wₘ is placed in the first column of the new latent feature matrix W_{new}.

If Pₘ is less than zero (branch “No” of S305), m-th column vector Zₘ of the binary matrix Z and m-th row vector Wₘ of the latent feature matrix W are discarded. That is, m-th column vector Zₘ and m-th row vector Wₘ are not appended (stored) in the matrices Z_{new} and W_{new}.

The loop variable m is incremented by 1 (step S307). If the loop variable m is greater than K (S308), the loop is exited, otherwise, the loop is repeated. In steps S305 to S307, row vectors of the estimated matrix W that contribute to a non-negative power value and thus are not discarded are collected in the new latent feature matrix W_{new}. Column vectors of the estimated binary matrix Z that are not discarded are collected in the new binary matrix Z_{new}.

If the new latent feature matrix W_{new} is equal to the estimated latent feature matrix W (branch “Yes” of S309), then the post process is ended, else (branch “No” of S309), the binary matrix Z is updated by the new binary matrix Z_{new} and the latent feature matrix W is updated by the new latent feature matrix W_{new} (S310). Then, the model estimation step (S301) is re-executed. That is, the latent feature model estimation step (S301) is performed to obtain a more appropriate solution: (Z, W), e.g., to re-estimate a latent feature matrix W′ and a binary matrix Z′ from the observation matrix X by using the updated matrices W and Z as initialization matrices. Regarding obtaining appropriate solution among equivalent solutions, reference may be made to NPTL 3.

The following describes the second example embodiment. As described with reference to FIG. 3, the residual fusion step (S204) is used to reduce an estimation error of the model (disaggregation error). The basic concept of the approach is to concatenate residual latent features to the estimated latent features and re-execute the model estimation for exact optimization with minimized error.

The residual latent features may be generated by any arbitrary process, method, any statistical model or the like. The basic method to generate residual latent features as follows:

The residual matrix can be generated by subtracting the estimated values from the measured values. Here, 2 cases may be possible.

One is to calculate a residual after the model estimation.

R=X−(Z·W) (5)

Other is to calculate a residual after the discard latent feature step (S203).

R=X−(Z′·W′) (6)

In each case, the residual matrix R is a residue or a remaining part of the measured data matrix X which is composed of N residue row vectors of D-dimension, where i-th residue row vector is given as

rᵢ=xᵢ−zᵢ·W, i=1, . . . ,N. (7)

The N×D residual matrix R is utilized as a new input data for any arbitrary model and new information can be generated from this residual matrix R. For example, applying a clustering model on the residual matrix R will generate clusters. The residual matrix R can be represented by these clusters. The cluster number for each of instances is estimated and transformed to a binary matrix Z_{R} of size N×k_{R} (N rows and k_{R} columns).

A value 1 of j-th element (j=1, . . . , k_{R}) of the vector of the binary matrix Z_{R}, represents presence of a relevant cluster (j-th cluster), while a value 0 thereof represents absence a relevant cluster (j-th cluster). It is noted that such model as, Histogram, Cluster, Combination, Gaussian Mixture Model, Classification, or the like can as a matter of course be used to generate the binary matrix Z_{R} from the residual matrix R.

Then, concatenation of the estimated latent feature (Z or Z′ (depend on the use)) and the new binary matrix Z_{R} is performed. The new updated matrices W and Z are used as input in the model with changed parameters and re-executed for the optimization.

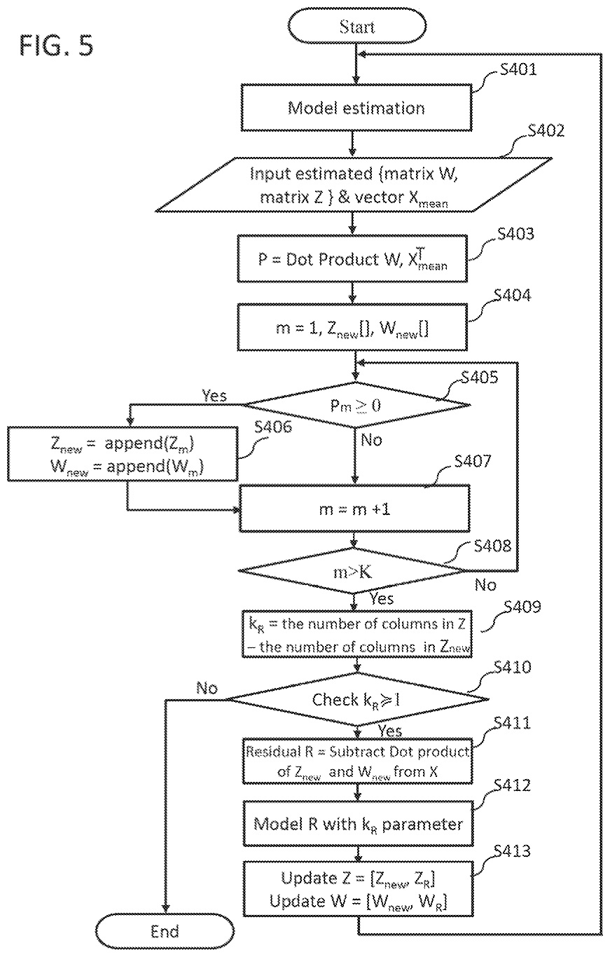

FIG. 5 is a flow chart diagram that illustrates the operation of the second embodiment and corresponds to a detailed version of the flow chart illustrated in FIG. 3. In FIG. 5, steps S401-S408 correspond to the steps S301-S308 and the description thereof is omitted.

In step S408, if the value of the loop variable m>K, the number of the column vectors in Z_{new} is subtracted from the number of the column vectors in Z to obtain k_{R}.

If k_{R} is greater than or equal to 1 (branch “Yes” of S410), then steps S411-S413 are executed and then the step S401 is re-executed. k_{R} is a positive integer which is used to identify the number of inverted waveforms that were present in the previous estimation of the latent feature matrix W and the binary matrix Z. k_{R} may be used to generate number of clusters, histograms bins, classification classes, models or the like.

In step S411, the residual matrix R, after the discard latent feature is calculated.

In step S412, the residual matrix R is modelled by utilizing k_{R} parameter to generate the binary matrix Z_{R}. The modelling of R matrix is done to create k_{R} number of clusters or groups present in the residual matrix R. For example, if the number of clusters are assumed as k_{R}, then a transformed binary matrix is generated. Each column of the binary matrix Z_{R} represents the cluster number, and (i,j) element of the binary matrix Z_{R} assume a value 1 to indicate presence of the cluster j otherwise zero.

In step S413, the N×k_{R} binary matrix Z_{R} generated after modelling the N×D residual matrix R is concatenated in columns with N×(K−k_{R}) binary matrix Z_{new} and the new N×K binary matrix Z is created by concatenation of Z_{new}, and Z_{R} ([Z_{new}, Z_{R}]). In the same manner, the K×D feature matrix W_{R} is concatenated in rows with (K−k_{R})×D feature matrix W_{new} and the new N×K feature matrix W is created by [W_{new}, W_{R}].

In step S401, based on the updated N×K binary matrix Z and K×D feature matrix W, the latent feature modeling is performed to estimate the latent feature matrix W and the binary matrix Z. The step S401 may perform the same latent feature model estimation step as step S301 in FIG. 4. That is, the step S401 may perform processing to obtain an appropriate solution: (Z, W), e.g., to re-estimate a latent feature matrix W′ and a binary matrix Z′ from the observation matrix X by using the updated matrices W and Z as initialization matrices.

If k_{R}=0 (Z==Z_{new}) (branch “No” of the step S410), that is, if the latent feature matrix W is composed of K non-inverted waveforms, the processing is ended.

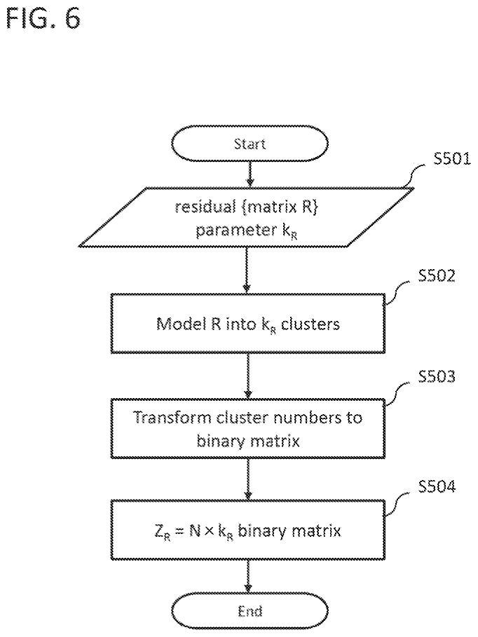

FIG. 6 is a flow chart diagram illustrating an example of the generation method of the binary features from the residual matrix.

In step S501, the N×D residual matrix R and the integer value k_{R} are inputted.

In step S502, the residual matrix R is modelled by using a clustering approach. The clustering result provides a residual feature value belong to which cluster.

In step S503, the clustering result is transformed into the binary matrix indicating, with a value 1, presence of the cluster at that time instant.

In step S504, the N×k_{R} binary matrix Z_{R} is generated based on clustering result of the N×D residual matrix R.

The second example embodiment may be combined with the first example embodiment. According to the above described example embodiments, it is possible to automatically optimize convergence of non-inverted waveforms. The latent feature model is employed to separate the waveform into each internal unit's waveform. Visualization of each internal unit of any electric appliance or facility is possible without any extra information like labels for each waveform. The present invention is also applicable in monitoring real time status of electric appliance into ON or OFF states.

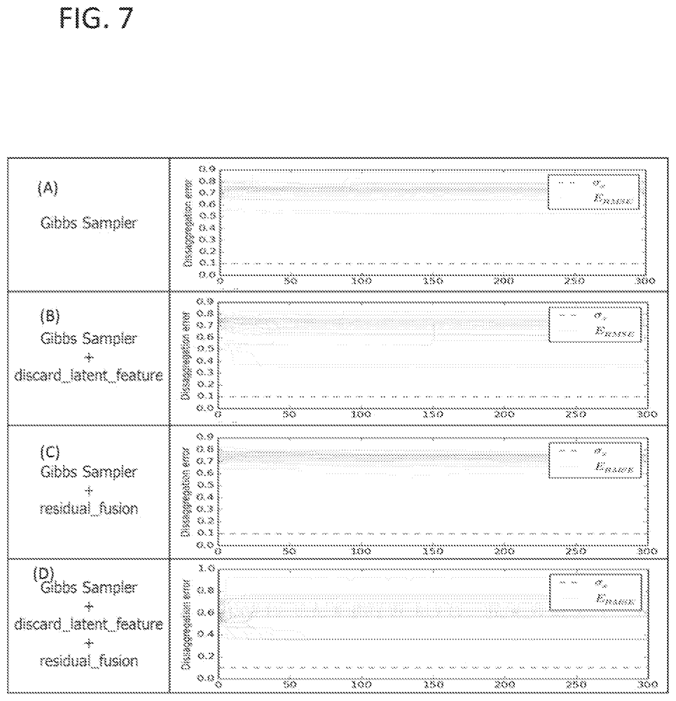

FIG. 7 is a chart illustrating the simulation result. The test scenario is designed to detect the change in the estimation error as compared with related arts. For simulation, synthetic data is created. The details of four test cases which are analyzed are as follows:

### (A) Related art: Gibbs Sampler;

(B) [Gibbs Sampler]+[Check inverted waveform]+[Discard latent feature];
(C) [Gibbs Sampler]+[Residual fusion]; and
(D) [Gibbs Sampler]+[Check inverted waveform]+[Discard latent feature]+[Residual fusion].

In FIG. 7, in each test case, the number of iterations for convergence is 300 (horizontal axis). The number of initial random seed parameter is 30. This means the model is iterated over 300 times for each different 30 initial parameters. In each of the test cases, a vertical axis is a disaggregation error, a solid line is an E_{RMSE} (root mean square error) and a broken line is a standard deviation of the matrix X, i.e., a kind of noise used to generate synthetic data (matrix X).

The test cases according to the present invention, outperforms the related art results as result graph can be read as follows for each test case;

(A) Output of the sampling method, i.e., Related art;
(B) Solution guarantees that it falls in non-inverted waveform local minima and eventually decreases error;
(C) Solution falls in local minima and does not decrease error; and
(D) Solution falls in local minima and guarantees non-inverted waveform local minima with minimized error after 50 iterations.

The combination of the three methods decreased error as compared to test case (A).

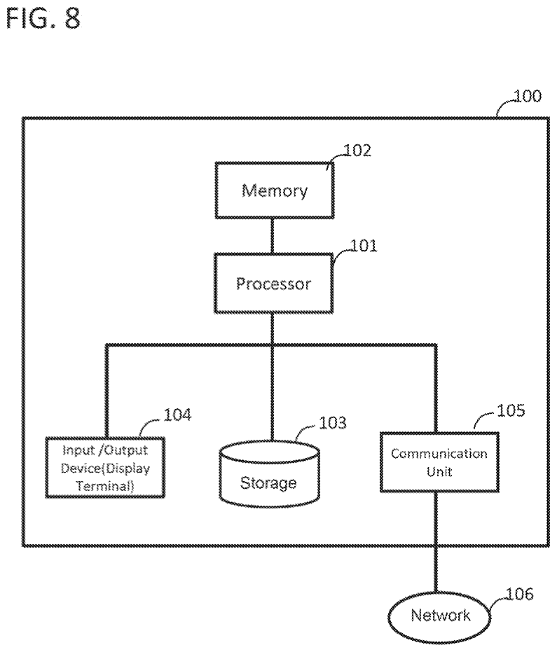

The unsupervised disaggregation apparatus (or system) described in the above example embodiments may be implemented on a computer system such as a server system (or a cloud system), as illustrated in FIG. 8, for example. Referring to FIG. 8, a computer system 100, such as a server system, includes a processor (Central Processing Unit) 101, a memory 102 that may include, for example, a semiconductor memory (for example, Random Access Memory (RAM), Read Only Memory (ROM), Electrically Erasable and Programmable ROM (EEPROM), and/or a storage device including at least one of Hard Disk Drive (HDD), Compact Disc (CD), Digital Versatile Disc (DVD) and so forth, an input/output device (display terminal) 104, and a storage database 103, a communication unit 105.

The computer system 100 can connect to a network 106 such as LAN (Local Area Network) and/or WAN (Wide Area Network) via the communication unit 105 that may include one or more network interface controllers (cards) (NICs). A program (instructions and data) for executing processing of the unsupervised disaggregation apparatus 100 in FIG. 8 is stored in the storage apparatus 103 and the processor 101 reads the program into a main memory provided in the memory 102, from the storage 103 to execute the program to realize the disaggregation apparatus that performs disaggregation of an aggregate waveform into individual waveforms of inner units based on latent feature model according to the example embodiments. The matrices X, W and Z, W_{new}, and Z_{new} may be stored in the storage apparatus 103 or the memory 102.

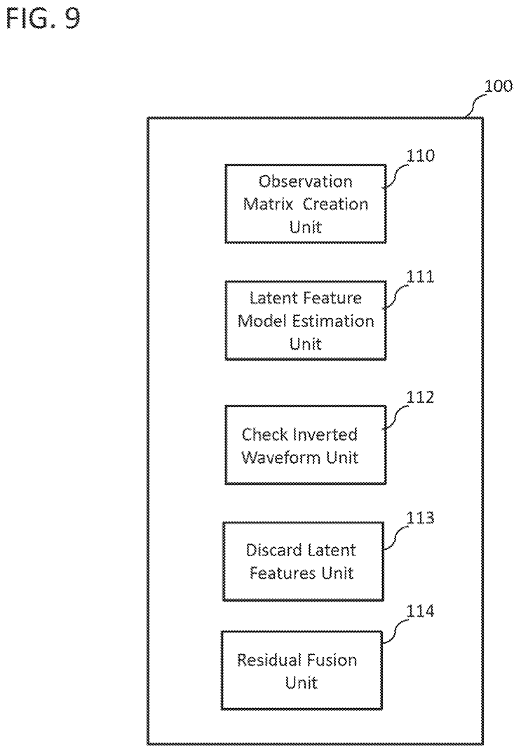

FIG. 9 illustrates the processing that processor 101 executes. A observation matrix creation unit 110 execute the processing of the step S200 in FIGS. 2 and 3. A latent feature model estimation unit 111 execute the processing of the step S201 in FIGS. 2 and 3. A check inverted waveform unit 112 executes the processing of the step S202 in FIGS. 2 and 3. A discard latent features unit 113 executes the processing of the step S203 in FIGS. 2 and 3. A residual fusion unit 114 executes the processing of the step S204 in FIG. 3.

Each disclosure of the aforementioned NPTL 1 to NPTL 3 is incorporated by reference herein. The particular example embodiments or examples may be modified or adjusted within the scope of the entire disclosure of the present invention, inclusive of claims, based on the fundamental technical concept of the invention. In addition, a variety of combinations or selections of elements disclosed herein may be used within the concept of the claims. That is, the present invention may encompass a wide variety of modifications or corrections that may occur to those skilled in the art in accordance with the entire disclosure of the present invention, inclusive of claims and the technical concept of the present invention.

What is claimed is:

1. An unsupervised disaggregation apparatus comprising a processor and a memory coupled to the processor and storing program instructions to be executed by the processor, the processor executing the program instructions to perform processing comprising:
creating an observation matrix X including N number of D-dimensional observation vectors, each composed of a measured aggregate waveform that is a sum of a plurality of individual waveform signals of a plurality of internal units;
estimating, by using a latent feature model approach, a binary matrix Z with N rows and K columns and a latent feature matrix W with K rows and D columns, from the observation matrix X with N rows and D columns, where N, D, and K are predetermined positive integers;
calculating a dot product of the latent feature matrix W and a D dimensional vector x, a dot product of which with each row of the latent feature matrix W is assumed to give a positive value;
repeating for i=1 to K, checking whether or not a result of the dot product for i-th (i is an integer from 1 to K) row of the latent feature matrix W with the D dimensional vector x is negative, and if the result of the dot product is negative, discarding the i-th row from the latent feature matrix W and discarding i-th column from the binary matrix Z;
checking whether or not there exists at least one discarded row in the latent feature matrix W, and as a result of the checking,
if there exists at least one discarded row in the latent feature matrix W,
using a new latent feature matrix W_{new}, each row thereof being a row of the latent feature matrix W, the dot product of the row thereof with the D dimensional vector x being non-negative and not discarded, updating the latent feature matrix W, and using a new binary matrix Z_{new}, each column thereof being a column of the binary matrix Z not discarded, updating the binary matrix Z; and
performing iteration from the estimation of the matrices Z and W from the observation matrix X using the updated matrices Z and W, until there is no discarded row in the latent feature matrix W.

2. (canceled)

3. The unsupervised disaggregation apparatus according to claim 1, wherein the processor further performs processing comprising:
as a result of the checking, if the number of discarded rows k_{R} in the latent feature matrix W is greater than or equal to 1,
calculating a residual matrix R by subtracting, from the observation matrix X, a dot product of a latent feature matrix W_{new}, each row thereof being a row of the latent feature matrix W, the dot product of the row thereof with the D dimensional vector x being non-negative and not discarded and a binary matrix Z_{new}, each column thereof being a column of the binary matrix Z not discarded;
modeling the residual matrix R by utilizing k_{R} parameter(s), to generate a binary matrix Z_{R} with N rows and k_{R} columns and the latent feature matrix W_{R} with k_{R} rows and D columns;
updating the binary matrix Z by concatenating the binary matrix Z_{R} in columns with the binary matrix Z_{new} and updating the latent feature matrix W by concatenating in rows the latent feature matrix W_{R} with the latent feature matrix W_{new}; and
performing iteration from the estimation of the matrices Z and W from the observation matrix X using the updated matrices Z and W, until there is no discarded row in the latent feature matrix.

4. The unsupervised disaggregation apparatus according to claim 3, wherein the processor performs the modeling of the residual matrix R utilizing k_{R} parameter(s) by clustering, wherein each column of the binary matrix Z_{R} represents a cluster number, and j-th (j=1, . . . , k_{R}) element of a row vector of the binary matrix Z_{R} assume a value 1 to indicate presence of the j-th cluster, otherwise zero.

5. The unsupervised disaggregation apparatus according to claim 1, wherein the processor performs detecting a negative value of the dot product for the row of the latent feature matrix W with the D dimensional vector x to find a waveform signal that is out of phase and stored in the row vector of the latent feature matrix W.

6. The unsupervised disaggregation apparatus according to claim 1, wherein the D dimensional vector x is a mean vector that is obtained by mean of N row vectors in the observation matrix X with N rows and D columns, or a row vector, a dot product of which with each row vector of the latent feature matrix gives a non-negative value.

7. The unsupervised disaggregation apparatus according to claim 1, wherein N cycles of a measured aggregate current waveform signal are stored in the N number of D-dimensional observation vectors.

8. A computer-based unsupervised disaggregation method comprising:
creating an observation matrix X including N number of D-dimensional observation vectors, each composed of a measured aggregate waveform that is a sum of a plurality of individual waveform signals of a plurality of internal units;
estimating, by using a latent feature model approach, a binary matrix Z with N rows and K columns and a latent feature matrix W with K rows and D columns, from the observation matrix X with N rows and D columns, where N, D, and K are predetermined positive integers;
calculating a dot product of the latent feature matrix W and a D dimensional vector x, a dot product of which with each row of the latent feature matrix W is assumed to give a positive value;
repeating for i=1 to K, checking whether or not a result of the dot product for the i-th row of the latent feature matrix W with the D dimensional vector x is negative, and if the result of the dot product is negative, discarding the i-th row from the latent feature matrix W and discarding i-th column from the binary matrix Z;
checking whether or not there exists at least one discarded row in the latent feature matrix W, and as a result of the checking,
if there exists at least one discarded row in the latent feature matrix W,
using a new latent feature matrix W_{new}, each row thereof being a row of the latent feature matrix W, the dot product of the row thereof with the D dimensional vector x being non-negative and not discarded, updating the latent feature matrix W, and using a new binary matrix Z_{new}, each column thereof being a column of the binary matrix Z not discarded, updating the binary matrix Z; and
performing iteration from the estimation of the matrices Z and W from the observation matrix X using the updated matrices Z and W, until there is no discarded row in the latent feature matrix W.

9. (canceled)

10. The computer-based unsupervised disaggregation method according to claim 8, further comprising:
as a result of the checking, if the number of discarded rows k_{R} in the latent feature matrix W is greater than or equal to 1,
calculating a residual matrix R by subtracting, from the observation matrix X, a dot product of a latent feature matrix W_{new}, each row thereof being a row of the latent feature matrix W, the dot product of the row thereof with the D dimensional vector x being non-negative and not discarded and a binary matrix Z_{new}, each column thereof being a column of the binary matrix Z not discarded;
modeling the residual matrix R by utilizing k_{R} parameter(s), to generate a binary matrix Z_{R} with N rows and k_{R} columns and the latent feature matrix W_{R} with k_{R} rows and D columns;
updating the binary matrix Z by concatenating the binary matrix Z_{R} in columns with the binary matrix Z_{new} and updating the latent feature matrix W by concatenating in rows the latent feature matrix W_{R} with the latent feature matrix W_{new}; and
performing iteration from the estimation step of the matrices Z and W from the observation matrix X using the updated matrices Z and W, until there is no discarded row in the latent feature matrix.

11. The computer-based unsupervised disaggregation method according to claim 10, wherein the modeling of the residual matrix R by utilizing k_{R} parameter(s) is performed by clustering, wherein each column of the binary matrix Z_{R} represents a cluster number, and j-th (j=1, . . . , k_{R}) element of a row vector of the binary matrix Z_{R} assume a value 1 to indicate presence of the j-th cluster, otherwise zero.

12. The computer-based unsupervised disaggregation method according to claim 8, comprising
detecting a negative value of the dot product for the row of the latent feature matrix W with the D dimensional vector x to find a waveform signal that is out of phase and stored in the row vector of the latent feature matrix W.

13. The computer-based disaggregation method according to claim 8, wherein the D dimensional vector x is a mean vector that is obtained by mean of N row vectors in the observation matrix X with N rows and D columns, or a row vector, a dot product of which with each row vector of the latent feature matrix gives a non-negative value.

14. A non-transitory computer-readable recording medium storing a program therein to cause a computer to execute processing comprising:
creating an observation matrix X including N number of D-dimensional observation vectors, each composed of a measured aggregate waveform that is a sum of a plurality of individual waveform signals of a plurality of internal units;
estimating, by using a latent feature model approach, a binary matrix Z with N rows and K columns and a latent feature matrix W with K rows and D columns, from the observation matrix X with N rows and D columns, where N, D, and K are predetermined positive integers;
calculating a dot product of the latent feature matrix W and a D dimensional vector x, a dot product of which with each row of the latent feature matrix W is assumed to give a positive value;
repeating for i=1 to K, checking whether or not a result of the dot product for the i-th row of the latent feature matrix W with the D dimensional vector x is negative, and if the result of the dot product is negative, discarding the i-th row from the latent feature matrix W and discarding i-th column from the binary matrix Z;
checking whether or not there exists at least one discarded row in the latent feature matrix W, and as a result of the checking,
if there exists at least one discarded row in the latent feature matrix W,
using a new latent feature matrix W_{new}, each row thereof being a row of the latent feature matrix W, the dot product of the row thereof with the D dimensional vector x being non-negative and not discarded, updating the latent feature matrix W, and using a new binary matrix Z_{new}, each column thereof being a column of the binary matrix Z not discarded, updating the binary matrix Z; and
performing iteration from the estimation of the matrices Z and W from the observation matrix X using the updated matrices Z and W, until there is no discarded row in the latent feature matrix W.

15. (canceled)

16. The non-transitory computer-readable recording medium according to claim 14, storing a program therein to cause the computer to execute processing comprising:
as a result of the checking, if the number of discarded rows k_{R} in the latent feature matrix W is greater than or equal to 1,
calculating a residual matrix R by subtracting, from the observation matrix X, a dot product of a latent feature matrix W_{new}, each row thereof being a row of the latent feature matrix W, the dot product of the row thereof with the D dimensional vector x being non-negative and not discarded and a binary matrix Z_{new}, each column thereof being a column of the binary matrix Z not discarded;
modeling the residual matrix R by utilizing k_{R} parameter(s), to generate a binary matrix Z_{R} with N rows and k_{R} columns and the latent feature matrix W_{R} with k_{R} rows and D columns;
updating the binary matrix Z by concatenating the binary matrix Z_{R} in columns with the binary matrix Z_{new} and updating the latent feature matrix W by concatenating in rows the latent feature matrix W_{R} with the latent feature matrix W_{new}; and
performing iteration from the estimation step of the matrices Z and W from the observation matrix X using the updated matrices Z and W, until there is no discarded row in the latent feature matrix.

17. The computer-based unsupervised disaggregation method according to claim 8, comprising:
storing N cycles of a measured aggregate current waveform signal in the N number of D-dimensional observation vectors.

18. The non-transitory computer-readable recording medium according to claim 16, wherein the program causes the computer to perform the modeling of the residual matrix R utilizing k_{R} parameter(s) by clustering, wherein each column of the binary matrix Z_{R} represents a cluster number, and j-th (j=1, . . . , k_{R}) element of a row vector of the binary matrix Z_{R} assume a value 1 to indicate presence of the j-th cluster, otherwise zero.

19. The non-transitory computer-readable recording medium according to claim 16, wherein the program causes the computer to perform detecting a negative value of the dot product for the row of the latent feature matrix W with the D dimensional vector x to find a waveform signal that is out of phase and stored in the row vector of the latent feature matrix W.

20. The non-transitory computer-readable recording medium according to claim 16, wherein the D dimensional vector x is a mean vector that is obtained by mean of N row vectors in the observation matrix X with N rows and D columns, or a row vector, a dot product of which with each row vector of the latent feature matrix gives a non-negative value.

21. The non-transitory computer-readable recording medium according to claim 16, wherein the program causes the computer to store N cycles of a measured aggregate current waveform signal in the N number of D-dimensional observation vectors.
